(19) United States
(12) Patent Application Publication
(10) Pub. No.: US 2011/0058147 A1
(43) Pub. Date: Mar. 10, 2011

(54) CLEANING MODULE AND EUV LITHOGRAPHY DEVICE WITH CLEANING MODULE

(75) Inventors: Dirk Heinrich Ehm, Lauchheim (DE); Julian Kaller, Koenigsbronn (DE); Stefan Schmidt, Aalen (DE); Dieter Kraus, Oberkochen (DE); Stefan Wiesner, Lauchheim (DE); Almut Czap, Aalen (DE); Hin-Yiu Anthony Chung, Elchingen (DE); Stefan Koehler, Rainau (DE)

(73) Assignee: Carl Zeiss SMT AG, Oberkochen (DE)

(21) Appl. No.: 12/893,762

(22) Filed: Sep. 29, 2010

Related U.S. Application Data
(63) Continuation of application No. PCT/EP2008/009754, filed on Nov. 9, 2008.
(60) Provisional application No. 61/042,061, filed on Apr. 3, 2008.
(60) Provisional application No. 61/083,811, filed on Jul. 25, 2008.

(30) Foreign Application Priority Data
Apr. 3, 2008 (DE) 10 2008 000 959.8
Jul. 25, 2008 (DE) 10 2008 040 720.8

(51) Int. Cl. G03B 27/52; C23F 1/08

(52) U.S. Cl. 355/30; 156/345.43; 156/345.46; 156/345.33

(57) ABSTRACT

A cleaning module for an EUV lithography device with a supply (206) for molecular hydrogen, a heating filament (210) and a line (212) for atomic and/or molecular hydrogen. The line (212) has at least one bend with a bending angle of less than 120 degrees, and has a material on its inner surface which has a low recombination rate for atomic hydrogen. The supply (206) is of flared shape at its end, which faces the heating filament (210). A gentler cleaning of optical elements is achieved with such a cleaning module, or also by exciting a cleaning gas with a cold cathode or a plasma, or by filtering out charged particles via of electrical and/or magnetic fields.

This is a Continuation of International Application PCT/EP2008/009754, with an international filing date of Nov. 19, 2008, which was published under PCT Article 21(2) in English, and which claims priority to DE 10 2008 000 959.8 filed Apr. 3, 2008, to U.S. 61/042,061 filed Apr. 3, 2008, to DE 10 2008 040 720.8 filed Jul. 25, 2008, and to U.S. 61/083,811 filed Jul. 25, 2008, the entire disclosures of which, including amendments, are incorporated into this application by reference.

### FIELD OF THE INVENTION AND BACKGROUND

The present invention relates to cleaning modules, in particular for an EUV lithography device, with a supply for a cleaning gas and a device for exciting the cleaning gas, as well as to a cleaning module, in particular for an EUV lithography device, with a supply for molecular hydrogen and a heating filament.

The present invention further relates to an EUV lithography device with such a cleaning module and to a projection system and to an exposure system for an EUV lithography device with such a cleaning module.

In EUV lithography devices, reflective optical elements for the extreme ultraviolet (EUV) or soft x-ray wavelength range (e.g. wavelengths between approx. 5 nm and 20 nm) such as photomasks or multilayer mirrors are used for the lithography of semiconductor components. As EUV lithography devices generally have a plurality of reflective optical elements, the latter must have a reflectivity which is as high as possible in order to ensure an overall reflectivity which is sufficiently high. The reflectivity and service life of the reflective optical elements can be reduced by contamination of the reflective surface, which is used optically, of the reflective optical elements, which contamination, on account of the short-wave irradiation, comes about together with residual gases in the operating atmosphere. As a plurality of reflective optical elements are usually arranged one behind the other in an EUV lithography device, even only smaller contaminations on each individual reflective optical element have a greater effect on the overall reflectivity.

Particularly the optical elements of an EUV lithography device can be cleaned in situ with the aid of atomic hydrogen, which in particular converts to volatile compounds with contamination, which contains carbon. Molecular hydrogen is often conducted onto a heated heating filament to obtain the atomic hydrogen. Metals or metal alloys with a particularly high melting point are used in the heating filament for this purpose. What are known as cleaning heads, and are made up of a hydrogen supply line and heating filament, are arranged in the vicinity of mirror surfaces in order to clean them of contamination. The volatile compounds which form during the reaction of the atomic hydrogen with the contamination, which contains carbon in particular, are pumped away using the normal vacuum system.

The problem with the previous approach is that on the one hand the cleaning heads should be arranged relatively closely to the mirrors in order to obtain a high degree of cleaning efficiency. On the other hand, optimized reflective optical elements are often heat-sensitive, in particular for the EUV or soft x-ray wavelength range. Heating up the mirrors too much during cleaning leads to an impairment of their optical characteristics. Until now, mirror cooling was therefore provided during the cleaning or the cleaning was carried out as pulsed cleaning with cool down phases.

A further problem consists in the fact that ionized particles can be produced when using known cleaning heads, which ionized particles are accelerated towards the mirror surface to be cleaned and could lead to damage to the surface by way of a sputter effect.

### SUMMARY OF THE INVENTION

It is an object of the present invention to improve the known cleaning heads to the effect that a gentler cleaning of the optical elements is enabled.

In a first aspect, this object is achieved by a cleaning module with a supply for a cleaning gas and a device for exciting the cleaning gas, in which the device for exciting comprises a cold cathode. Cold cathodes are cathodes for which, in contrast with hot cathodes, e.g. heating filaments, electron emission is induced not by strong heating, but rather by applying a high voltage.

In a second aspect, this object is achieved by a cleaning module with a supply for a cleaning gas and a device for exciting the cleaning gas, in which the device for exciting comprises a plasma generator.

Exciting a cleaning gas either by electron emission of a cold cathode or by a plasma has the advantage that heat production is negligible, so that no heat damage to the mirrors to be cleaned is to be feared, even if the cleaning modules are arranged in the immediate vicinity of the mirror surfaces to be cleaned. This has the additional advantage that an arrangement of one or a plurality of cleaning modules within an EUV lithography device is facilitated in the most space-optimized manner possible. Further, fewer ionized particles are produced in the case of these types of excitation than in the case of excitation by heat emission of electrons, so that even the risk of a sputter effect is smaller than in the case of previously known cleaning heads. Additionally, it may be mentioned that not only optical elements, but rather any desired surfaces can be cleaned gently with these cleaning modules.

Preferred embodiments have an outlet for the excited cleaning gas. A source for applying an electrical and/or magnetic field is arranged on the external side of the outlet. Ionized particles can be filtered out of the excited cleaning gas by the field(s). As a result, the likelihood of damage of the surfaces to be cleaned by sputter effects can be reduced considerably.

In a third aspect, this object is achieved by a cleaning module with a supply for a cleaning gas and a device for exciting the cleaning gas with a hot cathode, which cleaning module has an outlet for the excited cleaning gas and in the case of which cleaning module, a source for applying an electrical and/or magnetic field is arranged on the external side of the outlet, in order to avoid sputter effects on the surface to be cleaned.

In a fourth aspect, this object is achieved by a cleaning module with a supply for molecular hydrogen, a device for generating atomic hydrogen and a delivery line for atomic and/or molecular hydrogen, in which cleaning module the delivery line has at least one bend with a bending angle of less than 120 degrees, the delivery line has a material on its inner surface which has a low recombination rate for atomic hydrogen, and preferably, the supply is of flared shape at its end which faces the device for generating atomic hydrogen.

The atomic hydrogen generated at the device for generating atomic hydrogen, together with the usual molecular hydrogen if appropriate, can be conveyed via the delivery line from the device for generating atomic hydrogen to an object to be cleaned. Preferably, the device for generating atomic hydrogen is configured as a heating element, in particular as heating filament. Particularly in the case of the configuration as a heating element or heating filament, the bend in the line prevents a direct line of sight from the hot heating element or heating filament to the object to be cleaned. As a result, the heat load onto the object to be cleaned due to radiation and to convection from the heating element or heating filament is reduced effectively. The likelihood that the object to be cleaned, e.g. a mirror for EUV lithography, is damaged during the cleaning by too large a heat load is considerably reduced as a result. Even contamination by evaporation products from the heating element or heating filament is minimized effectively. At the same time, the special configuration of the line with a material which has a low recombination rate for atomic hydrogen on its inner surface ensures that, in spite of the spatial separation of the device for generating atomic hydrogen from the object to be cleaned, a satisfactory concentration of atomic hydrogen is provided by the line in order to be able to carry out an efficient cleaning.

This is also supported by the particular configuration of the supply for molecular hydrogen. The flared shape at its end which faces the device for generating atomic hydrogen ensures that a continuous flow of molecular hydrogen, which can be split into atomic hydrogen, is supplied to the device for generating atomic hydrogen over its entire superficial extent. Particularly in the case of the implementation of the device for generating atomic hydrogen as a heating element or heating filament, the heating output of the heating element or heating filament is used efficiently as a result and the rate of production for atomic hydrogen increased. Furthermore, the flared shape allows for a more homogeneous distribution of atomic hydrogen over the surface to be clean, this providing a gentler cleaning.

The use of a delivery line in order to transport the atomic hydrogen, mixed with molecular hydrogen if appropriate, to the location to be cleaned further has the advantage that other components which likewise should not be exposed to any heat load which is too high or should not come into contact with hydrogen concentrations which are too high are likewise less endangered.

The cleaning modules described are preferably used in EUV lithography devices for cleaning optical elements, but also other components and surfaces. Special optical elements based on multilayer systems are often heat-sensitive and are advantageously cleaned with the cleaning modules described. Test benches are a further preferred use location, in which test benches the conditions within an EUV lithography device are simulated for testing purposes.

The object is further achieved by an EUV lithography device with at least one previously described cleaning module. Additionally, the object is achieved by a projection system for an EUV lithography device and by an exposure system for an EUV lithography device, which have at least one such cleaning module.

The object is also achieved by using the described cleaning module for cleaning a component of an EUV lithography, in particular a mirror or a photo mask. Preferably, the cleaning module is used for cleaning the component in situ. Especially preferred, the cleaning module is used for cleaning the component in operando.

It may be pointed out that the cleaning modules described are also suitable in particular for cleaning masks for EUV lithography devices.

Advantageous configurations are to be found in the dependent claims.

### BRIEF DESCRIPTION OF THE DRAWINGS

The present invention is described in more detail with reference to preferred and/or exemplary embodiments. In the figures,

FIG. 1 shows schematically an embodiment of an EUV lithography device with cleaning modules according to the invention;

FIG. 2 shows schematically a first embodiment of a cleaning module;

FIG. 3 shows schematically a second embodiment of a cleaning module;

FIG. 4 shows schematically a special configuration of the flaring of the hydrogen supply and of the heating filament of a cleaning module;

FIG. 5 shows schematically a further embodiment of an EUV lithography device with cleaning modules according to the invention;

FIGS. 6a-d show schematically variants of a third embodiment of a cleaning module;

FIGS. 7a-d show schematically variants of a fourth embodiment of a cleaning module;

FIGS. 8a-c show schematically variants of a fifth embodiment of a cleaning module;

FIG. 9 shows schematically a sixth embodiment of a cleaning module;

FIG. 10 shows schematically a seventh embodiment of a cleaning module; and

FIG. 11 shows schematically an eighth embodiment of a cleaning module.

### DETAILED DESCRIPTION

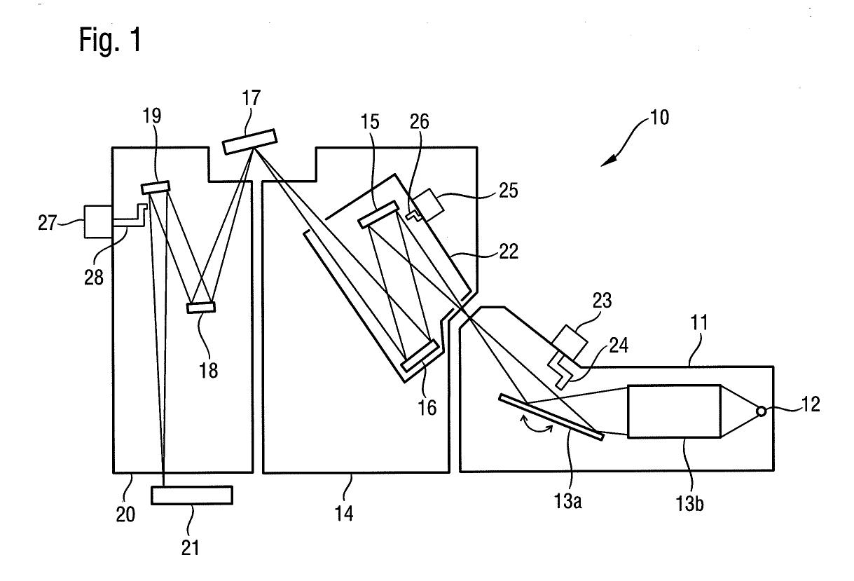

FIG. 1 schematically shows an EUV lithography device 10. Primary components are the beam forming system 11, the exposure system 14, the photomask 17 and the projection system 20. The EUV lithography device 10 is operated under vacuum conditions so that the EUV radiation in its interior is absorbed as little as possible.

A plasma source or also a synchrotron can be used as a radiation source 12, for example. The emitting radiation in the wavelength range from approximately 5 nm to 20 nm is initially focussed in the collimator 13b. In addition, the desired operating wavelength is filtered out by varying the angle of incidence with the aid of a monochromator 13a. In the wavelength range mentioned, the collimator 13b and the monochromator 13a are usually configured as reflective optical elements. Collimators are often reflective optical elements which are configured to be bowl-shaped in order to achieve a focussing or collimating effect. The radiation is reflected on the concave surface, wherein a multilayer system is often not used, because on the concave surface a wavelength range, which is as wide as possible, should be reflected. The filtering of a narrow wavelength band by reflection takes place at the monochromator, often with the aid of a grid structure or a multilayer system.

The operating beam prepared with respect to wavelength and spatial distribution in the beam forming system 11 is then fed into the exposure system 14. In the example shown in FIG. 1, the exposure system 14 has two mirrors 15, 16, which are configured as multilayer mirrors in the present example. The mirrors 15, 16 guide the beam onto the photomask 17, which has the structure, which is to be reproduced on the wafer 21. The photomask 17 is likewise a reflective optical element for the EUV and soft wavelength range, which can be exchanged, depending on the manufacturing process. The beam reflected by the photomask 17 is projected onto the wafer 21 with the aid of the projection system 20 and, as a result, the structure of the photomask reproduced on it. In the example shown, the projection system 20 has two mirrors 18, 19 which are likewise configured as multilayer mirrors in the present example. It may be pointed out that both the projection system 20 and the exposure system 14 can likewise have only one or even three, four, five and more mirrors in each case.

Both the beam forming system 11 and the exposure system 14 and the projection system 20 are configured as vacuum chambers, as the multilayer mirrors 15, 16, 18, 19 in particular can only be operated in a vacuum. Otherwise, too much contamination would be deposited on their reflective surface, which contamination would lead to too severe an impairment of their reflectivity.

Contamination which is already present can be removed with the aid of cleaning modules based on atomic hydrogen or other cleaning gases. As in the example shown in FIG. 1, three cleaning modules 23, 25, 27 are provided representatively for this purpose. The delivery line 24 of the cleaning module 23 projects into the vacuum chamber of the beam forming system 11 in order to remove contamination on the monochromator 13a. The delivery line 28 of the cleaning module 27 projects into the vacuum chamber of the projection system 20 in order to clean the surface of the mirror 19. The moveable arrangement of the delivery line 28 allows the cleaning module 27 to also be used for the cleaning of the mirror 18.

It may be pointed out that a cleaning module can also be arranged in the region of the photomask 17 for its cleaning.

In the case of the exposure system 14, the mirrors 15, 16 are enclosed in a capsule 22 which defines a vacuum chamber with its own microenvironment within the vacuum chamber of the exposure system 14. The encapsulation of the mirrors 15, 16 has the advantage that contaminating substances from outside the capsule 22 are prevented from penetrating through to the mirrors 15, 16 and contaminating their surface. In addition, barely any hydrogen atoms or other excited cleaning gases, which are conveyed from the cleaning module 25 into the capsule 22 via the delivery line 26 for cleaning purposes, make it to outside of the capsule 22. As a result, it is possible to use components in the exposure system 14 outside of the capsule 22, which contain materials which have a higher rate of reaction with atomic hydrogen in particular or other excited cleaning gases and would otherwise be acted on by atomic hydrogen or other excited atoms or molecules, which would lead to a shorter service life of these components.

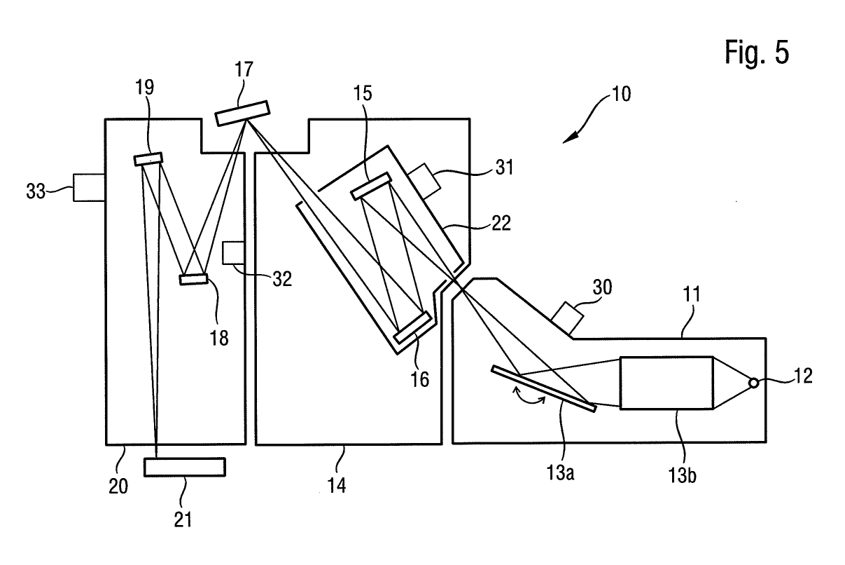

The previous comments on FIG. 1 also apply to the example of an EUV lithography device 10 shown in FIG. 5 as a schematic diagram, the same reference numbers designating the same components in FIG. 1 and FIG. 5.

It may be mentioned that a capsule with cleaning module, as described here in connection with the exposure system 14, can be provided in the same manner in the projection system 20 for encapsulating one or a plurality of the mirrors 18, 19 located there. Likewise, at least one cleaning module can also be provided in the exposure system 14, which cleaning module, as in the projection system 20, can be arranged outside of the vacuum chamber which defines the exposure system 14, so that only one supply line projects into the vacuum chamber. A plurality of cleaning modules can further be provided for a vacuum chamber, which cleaning modules can be arranged in any desired combination with some of the cleaning modules completely in the vacuum chamber, and/or having the delivery line outside the vacuum chamber, and/or if appropriate having the delivery line outside a capsule and/or, if appropriate, completely in a capsule, as is also shown in FIG. 5. However, the cleaning modules 30-33 in the example shown in FIG. 5 do not have any delivery lines, but rather only an outlet for excited cleaning gas. If the cleaning modules are arranged outside of a vacuum chamber, as e.g. the cleaning modules 30, 31, 33, they are arranged in such a manner that the cleaning module is connected to the respective vacuum chamber via the outlet.

It may be pointed out that in the example shown in FIG. 1 only three cleaning modules 23, 25, 27 or in the example shown in FIG. 5 only four cleaning modules 30, 31, 32, 33 are provided. Depending on the requirements for the cleaning action, one or more cleaning modules can also be provided for each individual optical element. In the example shown in FIG. 1, the protective modules 23, 25, 27 are, in addition, except for their delivery lines 24, 26, 28, not arranged in the same vacuum chamber as the respective optical system to be cleaned. This could also be done for example in the case of the cleaning module 32 in FIG. 5. However, for the case of excitation of the cleaning gas by a hot cathode, arrangement of the part of the cleaning module, which comprises respectively a heating filament or a hot cathode for generating atomic hydrogen or for exciting another cleaning gas, outside of the vacuum chamber in which the optical element to be cleaned is immediately located, can be more clearly reduce the heating load due to radiation and convection on the optical element to be cleaned. This leads to an even gentler cleaning.

All three cleaning modules 23, 25, 27 shown in FIG. 1 have delivery lines 24, 26, 28 which are bent at least once by at most 120 degrees. In the present example they are bent twice by approximately 90 degrees. As a result, a direct line of sight between the heating filament and the optical element to be cleaned is avoided and the heat load due to radiation and convection is minimized, particularly when using a hot cathode or a heating filament to excite the cleaning gas. A further advantage of the positioning of the part of the cleaning module, which contains the heating filament, lies in the fact that even remaining components within the EUV lithography device are exposed to a lower heat load. This has e.g. advantages for the overall mechanical structure which is necessary for exact orientation of the mirrors in the path of the beam. Only a few corrections need to be carried out due to heat expansion of the mechanical components, which overall leads to a better imaging characteristic of the EUV lithography device.

The cleaning modules 23, 25, 27 can incidentally also be used to rinse the vacuum chamber, into which their respective delivery line 24, 26, 28 projects, with molecular hydrogen or another cleaning gas if no cleaning is being carried out at the time and the respective heating filament or other device for exciting the cleaning gas is therefore not switched on. The hydrogen rinsing or cleaning gas rinsing prevents contaminating substances such as, e.g. hydrocarbons or even tin, zinc, sulphur or compounds containing these substances from reaching the collimator 13b or the monochromator 13a, or the EUV mirrors 18, 19, 15, 16 and being deposited there as contamination on the surfaces which are used optically. The rinsing can also be carried out during the operation of the EUV lithography device 10. In this case, the EUV radiation leads to a part of the molecular hydrogen being split into atomic hydrogen or cleaning gas being excited, which atomic hydrogen or cleaning gas can, for its part, react with contamination which is already present to form volatile compounds. These are pumped away by the pump systems (not shown) which are provided for every vacuum chamber anyway.

The concept of the hydrogen rinsing or rinsing with another cleaning gas is particularly advantageous if optical elements, such as the mirrors 15, 16 of the exposure system 14 in the example shown, are enclosed in a separate capsule 22 in their own microenvironment. The hydrogen supplied through the delivery line 26 or the supplied cleaning gas is used for rinsing and at the same time maintaining an overpressure with respect to the region outside the capsule of preferably approximately 0.01 mbar to 0.5 mbar. The overpressure is used to prevent contaminating substances from penetrating into the interior of the capsules 22. In order to maintain the overpressure efficiently, only small supply line cross sections are allowed for the supply of other gases such as for example the atomic or the molecular hydrogen or another cleaning gas, which cross sections can be kept to without any problems using the delivery lines of the cleaning modules suggested here. In order to control the overpressure, if required, e.g. the ratio of molecular to atomic hydrogen can be regulated by the temperature of the heating filament and the gas pressure, or the heating filament and therefore the atomic hydrogen can be switched off completely in phases between two cleanings. The supply of a cleaning gas into the cleaning module can likewise be regulated.

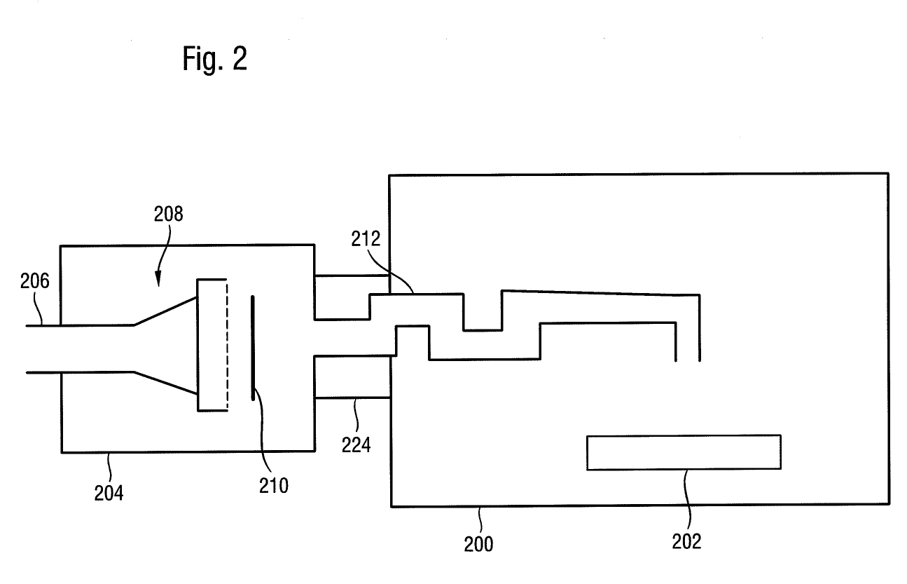

FIG. 2 schematically shows the structure of a first embodiment of a cleaning module for use in EUV lithography devices or test benches in which the conditions within EUV lithography devices are simulated for testing purposes or preparatory measurements are made on components before they are used in EUV lithography devices. The cleaning modules are used for cleaning any desired components, particularly optical components such as for example mirrors and masks among others.

The first embodiment is explained by way of example with reference to the exciting of molecular hydrogen to atomic hydrogen with a hot cathode. The explanations likewise relate to the exciting of another cleaning gas, such as nitrogen- oder hydrogen-containing gases, e.g. nitrogen, nitrogen monoxide, carbon monoxide or methane among others, with which not only contaminations which contain carbon but also contaminations which contain tin, zinc or sulphur can be removed in particular by conversion to volatile compounds which can be pumped away.

A heating filament 210 is arranged in a housing 204 as hot cathode. In particular metals and metal alloys with a very high melting point are suitable as material for the heating filament 210 so that the heating filament can be heated up to correspondingly high temperatures.

The production rate of atomic hydrogen rises at high temperatures. The heating filament 210 can for example be made from tungsten with which the temperatures of approx. 2000° C. can be obtained. A supply 206 with flare 208 for the supply of molecular hydrogen opens into the housing 204. The supply line 206 flares at its end, which faces the heating filament 210 so that the heating filament is exposed to molecular hydrogen over its entire length and its heating output is therefore used optimally for the conversion of molecular into atomic hydrogen.

The delivery line 212 branches off from the housing 204 in order to transport the atomic and/or molecular hydrogen into the vacuum chamber 200 in which the optical element 202 to be cleaned is arranged. The delivery line 212 is bent multiple times with bending angles of less than 120°. As a result, a direct line of sight between heating filament 210 and optical element 202 to be cleaned is avoided, which direct line of sight would lead to an increased heat load due to radiation and convection. Even the contamination of the surface to be cleaned due to evaporation products from the heating filament, e.g. tungsten is minimized effectively.

Cooling 224 is provided in the region of the delivery line 212 directly adjacent to the housing 204 in the example shown in FIG. 2 as an additional measure against the undesirable heat load during cleaning with atomic hydrogen. The gas transported through the delivery line 212 can be significantly cooled by the cooling 224 directly in the region of the delivery line 212, which is located in the vicinity of the heating filament 210.

The delivery line 212 in the present example is made from metal in order to achieve a good cooling action. So that, on the one hand, the inner surface of the deliver line is not acted on by atomic hydrogen and converted to hydrides and, on the other hand, the recombination rate of the atomic hydrogen to molecular hydrogen is as low as possible, the inner surface of the line 212 is coated with a material which has a lower combination rate for atomic hydrogen. Particularly preferred are coatings with polytetrafluoroethylene or with phosphoric acid. Particularly low recombination rates were observed in the case of a coating with silicon dioxide. A silicon dioxide layer can, for example, be applied to metal surfaces in that perhydrosilazane is used as a precursor and this perhydrosilazane layer is allowed to oxidize in air atmosphere and at temperatures of approximately 130° C. or more. The special coating of the inner surface of the line 212 ensures that a maximum of the hydrogen atoms generated at the heating filament 210 passes through the stretch through the delivery line 212 and can be supplied to the surface to be cleaned of the optical element 202. This effect is amplified further by the cooling 224.

The shape and the dimensions of the delivery line 212 are incidentally selected, in as much as this is possible, as a function of the respective actual geometric realities so that the delivery line 212 opens in the region of the surface to be cleaned in order to achieve the desired cleaning effect. The bending angle(s) can be selected as a function of the geometric realities, too.

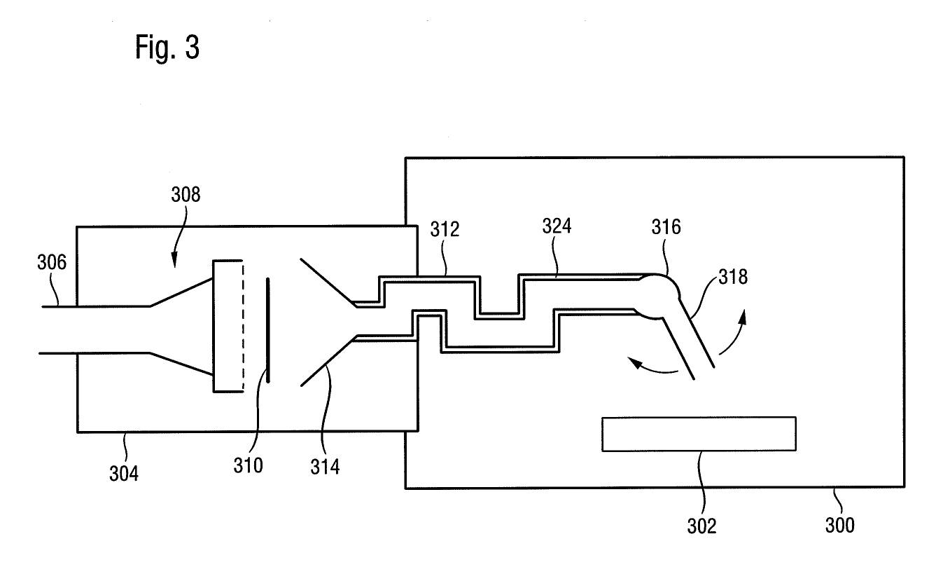

FIG. 3 shows a further configuration of a cleaning module by way of example for an exciting of hydrogen using a hot cathode. The cleaning module shown in FIG. 3 differs from the exemplary embodiment shown in FIG. 2 in particular with respect to the configuration of the delivery line 312. In the example shown in FIG. 3, the delivery line 312 is essentially a multiply bent, double-walled and water-cooled glass capillary, the dimensions of which are adapted to the actual geometric realities. As an alternative to glass, the delivery line 312 can also be produced from quartz. Quartz glass is particularly preferred. Both quartz and glass have a particularly low recombination rate for atomic hydrogen. The region between the two walls of the delivery line 312 is used as cooling 324 by feeding through a cooling medium, preferably water. Cooling the transported gas over a substantial part of the length of the delivery line 312 allows the heat load on the optical element 302 to be cleaned to be minimized particularly well during the cleaning with atomic hydrogen. In order to bring the hydrogen atoms generated at the heating filament 310 through the delivery line 312 to the optical element 302 to be cleaned in the highest possible quantity, the delivery line 312 is flared in the shape of a funnel at its end 314, which faces the heating filament 310. As a result, the likelihood of a hydrogen atom generated at the heating filament 310 finding the way into the delivery line 312 is increased.

A further distinctive feature of the example shown in FIG. 3 consists in the fact that the delivery line 312 has a hinge 316 at its end which projects into the vacuum chamber 300 in order to configure the end piece 318 of the line 312 in a moveable manner. Rendering the end piece 318 moveable relative to the surface to be cleaned of the optical element 302, allows regions of the optical element 302 to be cleaned to be reached, too, which otherwise would be shadowed. A selective cleaning of individual surfaces or surface elements is therefore now possible, for example as a function of measured or calculated local degree of contamination. In a further development of the example shown in FIG. 3, the delivery line can additionally be configured displaceably in order to, for example, allow the end piece 318, via which the hydrogen atoms required for the cleaning are supplied, to be pushed into the path of the beam. As a result, even more different surface elements can be reached and directly subjected to atomic hydrogen during the cleaning phases.

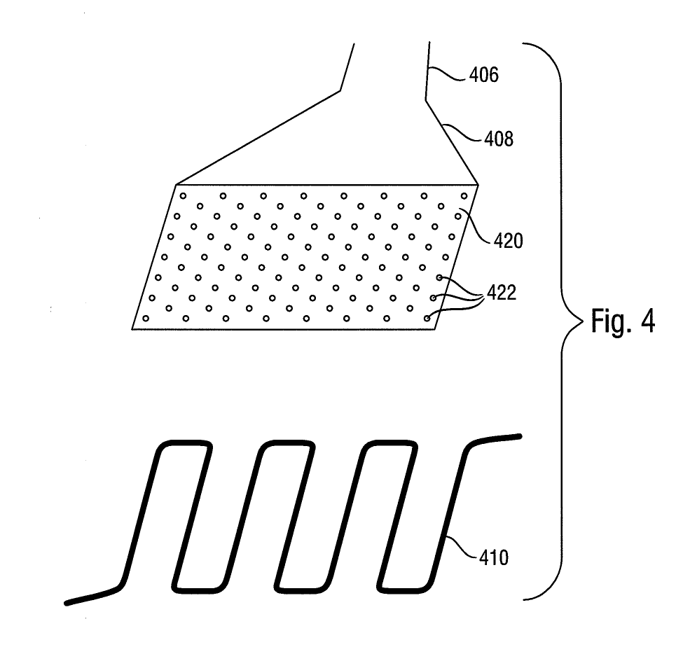

A further enhancement of the cleaning modules explained here for increasing the cleaning efficiency by increasing the production rate for atomic hydrogen is shown in FIG. 4. The heating filament 410 is spread out over a surface. In the example shown in FIG. 4, the heating filament 410 has a plurality of windings for this purpose. Adapted to the surface spanned by the heating filament 410, the supply line 406 for the molecular hydrogen is also flared in two dimensions. The flaring 408 is terminated in the manner of a shower head with a closing plate 420. The closing plate 420 comprises a multiplicity of openings 422 through which the molecular hydrogen passes and flows onto the heating filament 410, where it is split into atomic hydrogen. In contrast to a two dimensional flaring 408 without closing plate 420, this has the advantage that when leaving the small openings 422, the hydrogen molecules are accelerated and as a result flow onto the heating filament 410 in a targeted manner.

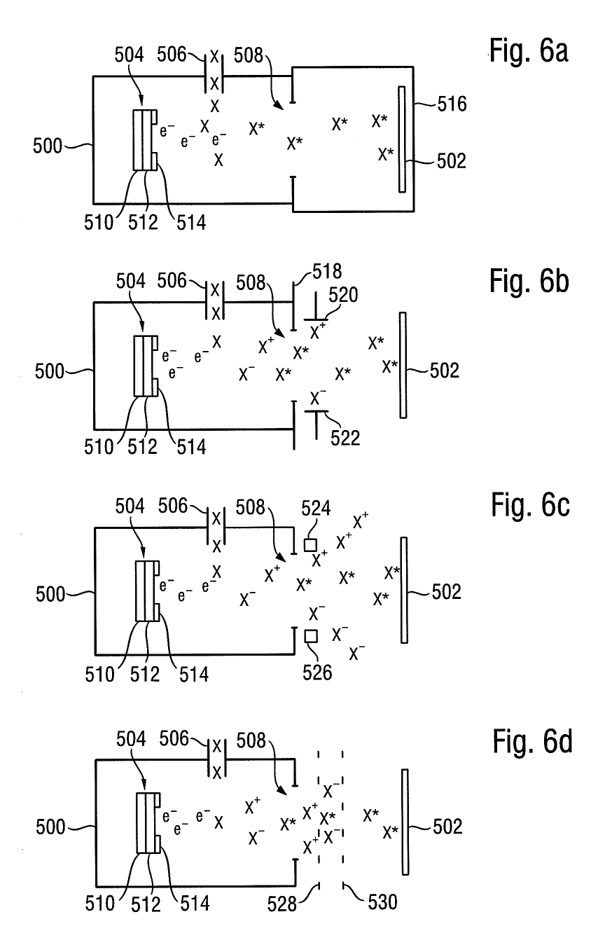

A further exemplary embodiment of a cleaning module for a gentle cleaning of surfaces, particularly within an EUV lithography device, but that can also be used in test benches however, is shown in a plurality of variants in FIGS. 6a-d. The cleaning module 500 has a cold cathode 504 for exciting a cleaning gas X, preferably one or more gases as cleaning gas of the group consisting of nitrogen-containing gases and hydrogen-containing gases, particularly preferred e.g. nitrogen, nitrogen monoxide, carbon monoxide or methane, but also hydrogen.

A cold cathode differs from a hot cathode to the effect that an electron emission is not induced by heating, but rather by applying a high voltage. For this purpose, the cold cathode 504 has a sandwich-like construction in the example shown in FIGS. 6a-d. Arranged opposite the bottom layer 510 is a top layer 504, wherein the top layer 514 does not cover the entire bottom layer 510, but rather leaves free one or a plurality of openings, through which the emitted electrons e⁻ can escape. In order to increase the efficiency of the cold cathode 504, an intermediate layer 512 made up of a dielectric or preferably a ferroelectric material is arranged between the bottom layer 510 and the top layer 514. To operate the cold cathode 504, each of the layers 510, 514 is connected to a power supply (not shown) which for their part are connected to a voltage source (not shown) which supplies a voltage signal with alternating polarities.

The electrons e⁻ emitted from the cold cathode 504 interact with the cleaning gas X which is supplied via the supply 506 so that excited atoms or molecules X* are formed. There is no damaging heat generation in the process. Also, positive or negative ions X⁺ or X⁻ are formed hardly or only with low energy so that no serious sputter effect is to be expected. The excited cleaning gas X* escapes from the cleaning module 500 through the outlet 508 and comes into contact with the surface to be cleaned of the cleaning object 502, e.g. a mirror or another surface within an EUV lithography device and can deploy its cleaning action.

The cleaning module 500 can be arranged directly within the vacuum chamber, in which the cleaning object 502 is located, as shown for example in the FIGS. 6c,d. It can however also be arranged outside a vacuum chamber 516, 518 in such a manner that it is connected to the vacuum chamber via the outlet 508. The vacuum chamber may be a larger vacuum chamber 518 (see FIG. 6b) in which a multiplicity of components may be arranged such as for example an exposure or projection or beam forming system of an EUV lithography device. The vacuum chamber may also be a vacuum chamber 516 which is used for encapsulating particularly sensitive components, such as for example mirrors with a multilayer coating (see FIG. 6a).

In the event that the surface to be cleaned of the cleaning object is very sensitive, the ions X⁺, X⁻ formed during the exciting of the cleaning gas can be filtered out by electrical and/or magnetic fields so that they do not impinge on the surface to be cleaned and damage it. In the FIGS. 6b-d are shown schematically by way of example a number of arrangements for applying electrical or magnetic fields which can be expanded and combined with one another as desired. In the FIGS. 6b,d a pair of electrodes 520, 522 (FIG. 6b) or a pair of grids 528, 530 (FIG. 6d) of opposite polarity, which in each case attract negative or positive ions, is provided for applying an electrical field. In the example shown in FIG. 6c, magnetic fields are applied by two magnets 524, 526 which divert the ions so that they do not impinge onto the cleaning object 502. Particularly in the event that only ions of one polarity should be removed, even only one electrode, one grid or one magnet or another arrangement for applying an electrical and/or magnetic field respectively is sufficient. Depending on the geometry, a plurality of arrangements of one type can be combined with one another or with others.

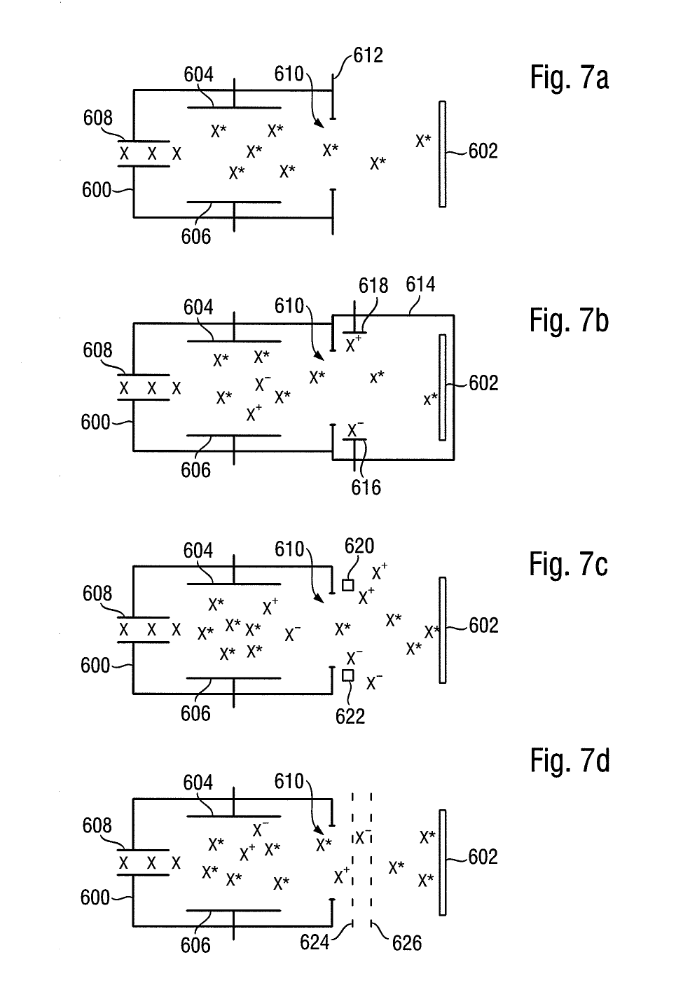

FIGS. 7a-d show a further embodiment of a cleaning module in a number of variants. The cleaning module 600, to which the previously mentioned cleaning gases X are preferably supplied via the supply 608, has a plasma generator to excite the cleaning gas. In the example shown in FIGS. 7a-d there are electrodes 604, 606 arranged opposite one another between which the cleaning gas is introduced. By applying a corresponding DC or AC voltage to the electrodes, the cleaning gas is excited to such a degree that a plasma is ignited. Excited atoms or molecules X* of the cleaning gas escape from the plasma, which atoms or molecules reach the surface of the cleaning object 602 through the outlet 610 and deploy their gentle cleaning action there. As in the event of exciting using a cold cathode, no damaging heat generation which would have a negative effect on neighbouring components is to be observed in the case of a plasma excitation. Ions are formed in only a small amount which, if appropriate, can be filtered out using electrodes 618, 616, grids 624, 626, magnets 620, 622 or another manner of applying electrical and/or magnetic fields, which can be combined as desired depending on requirements.

The cleaning module 600, too, can be arranged within (FIGS. 7c, d) or outside (FIGS. 7a, b) a vacuum chamber 612, 614, wherein the cleaning module 600 is connected to the vacuum chamber 612, 614 via the outlet 610. In all examples, the outlet can incidentally be configured as an opening or have a certain extension, e.g. in the manner of a flange.

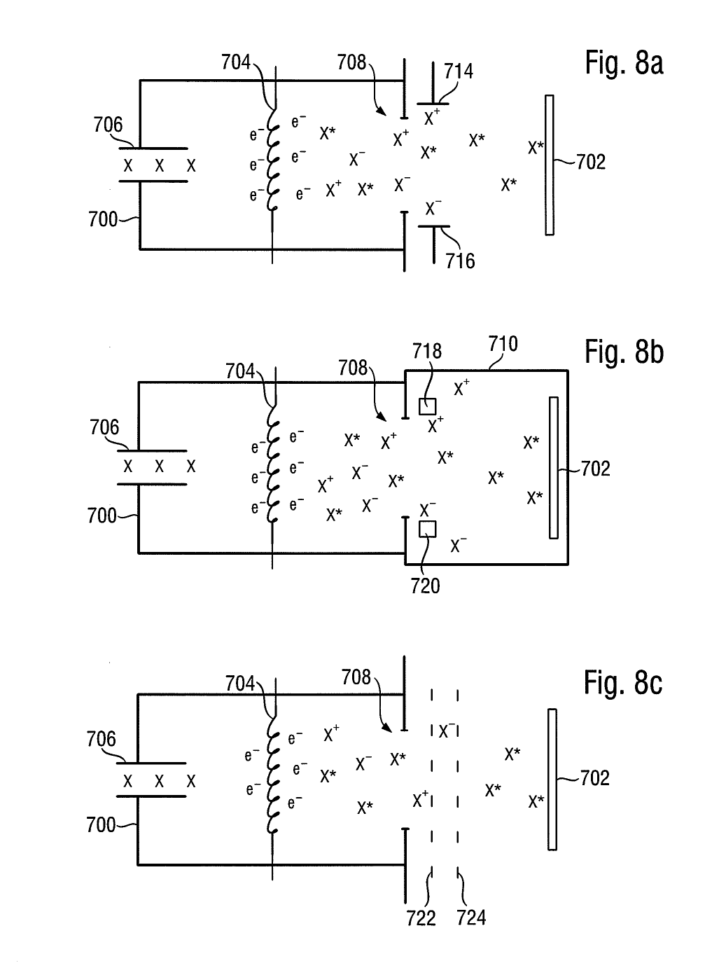

FIGS. 8a-c show a further embodiment of a cleaning module 700 in a number of variants. The exciting particularly of the already mentioned cleaning gases X takes place in this exemplary embodiment by thermionic electron emission from a hot cathode which is configured as a coiled filament 704 in the example shown in the FIGS. 8a-c. The cleaning gas is conveyed via the supply 706 to the coiled filament 704 where it interacts with the emitted electrons. In the process excited atoms and molecules and also positive and negative ions are formed. In order to clean the surface of the cleaning object 702 as gently as possible and avoid negative sputter effects, the ions are filtered out using electrical and/or magnetic fields. Electrodes 714, 716, magnets 718, 720 and grids 722, 724 are used for this purpose in the example shown in the FIGS. 8a-c. However, other suitable ways of applying electrical and/or magnetic fields can also be used. Depending on the geometry of the cleaning module 700 and of the cleaning object 702, diverse arrangements can be combined with one another in order to apply the optimized fields for the respective use. The cleaning module 700 as well can be arranged within a vacuum chamber (FIG. 8a) or outside a vacuum chamber 710, 712 and connected to the latter via the outlet 708.

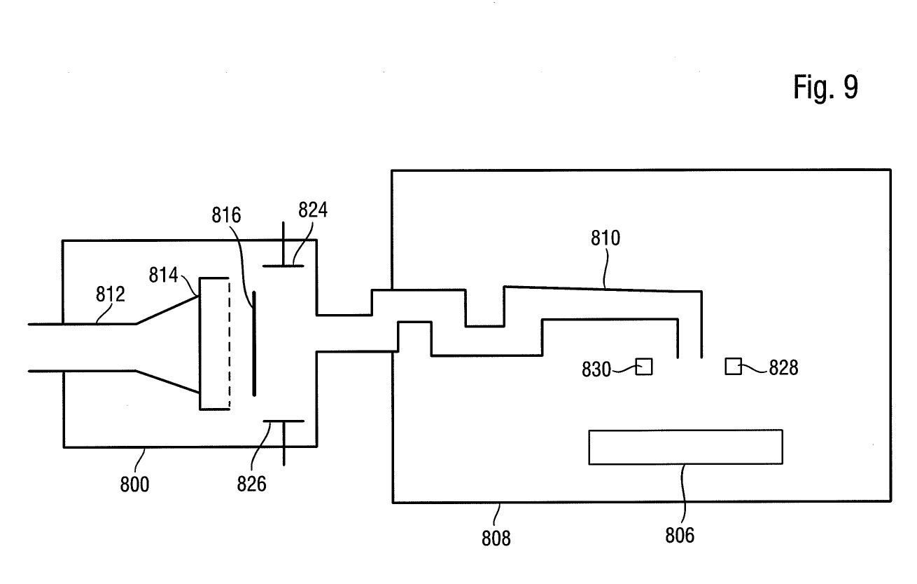

FIGS. 9 to 11 show further embodiments of cleaning modules 800, 801, 802, in which the outlet is configured as a delivery line 810. The cleaning modules 800, 801, 802 are arranged outside of the vacuum chamber 808 in such a manner that only the delivery line 810 projects into the interior of the vacuum chamber 808, where the cleaning object 806 is also arranged. The cleaning object 806 may be a mirror for example, the surface of which is contaminated, or another component or even an inner wall of the vacuum chamber 808 in the event that this requires cleaning. The vacuum chamber 808 may be a large vacuum chamber such as for example an exposure, projection or beam forming system of an EUV lithography device, an encapsulating vacuum chamber for protecting particularly sensitive components such as for example EUV mirrors or also the vacuum chamber of a test bench.

As in the examples already shown in FIGS. 2 and 3, the delivery line 810 has a plurality of bends in order to prevent or at least to reduce a possible heat load on the vacuum chamber. Additionally, cooling units can also be provided at the delivery line. In order to ensure a high transmission rate of excited atoms or molecules of the cleaning gas used, preferably one or more gases as cleaning gas of the group consisting of nitrogen-containing gases and hydrogen-containing gases, particularly preferred e.g. nitrogen, nitrogen monoxide, carbon monoxide, methane or hydrogen, the delivery line 810 can be made from a material that has a low recombination rate for the cleaning gas used in each case or at least have an inner coating made from such a material.

The cleaning module 800 shown in FIG. 9 has a heating filament 816 for exciting the cleaning gas. In order to increase the excitation efficiency, the cleaning gas supply 812 has a flaring 814 in the direction of the heating filament 816, which is configured in the manner of a shower head as also explained with reference to FIG. 4. In order to filter out damaging ions, electrodes 824, 826 are arranged between the heating filament 816 and delivery line 810 in the example shown in FIG. 9. Should the ions nonetheless make it through the delivery line 810 as far as the interior of the vacuum chamber 808, there they are diverted with the aid of magnets 828, 830 so that they do not impinge onto the surface of the cleaning object 806 to be cleaned.

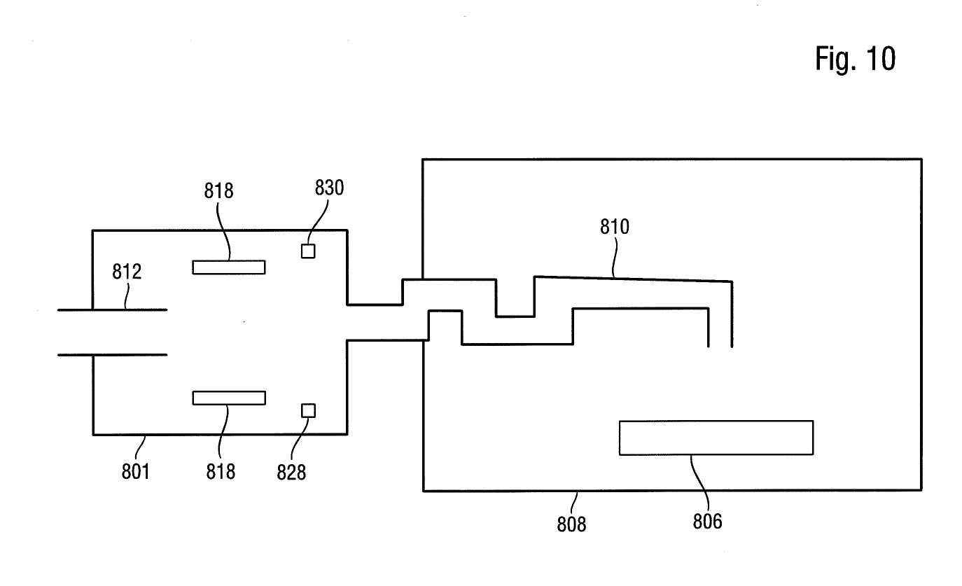

Two cold cathodes 818 are arranged in the cleaning module 801 shown in FIG. 10, in order to excite the cleaning gas introduced via the supply 812. Ions which are produced in the process are, if appropriate, diverted by magnets 828, 830 arranged between the cold cathodes 818 and the line 810, so that they do not make it into the interior of the vacuum chamber 808 by the line 810.

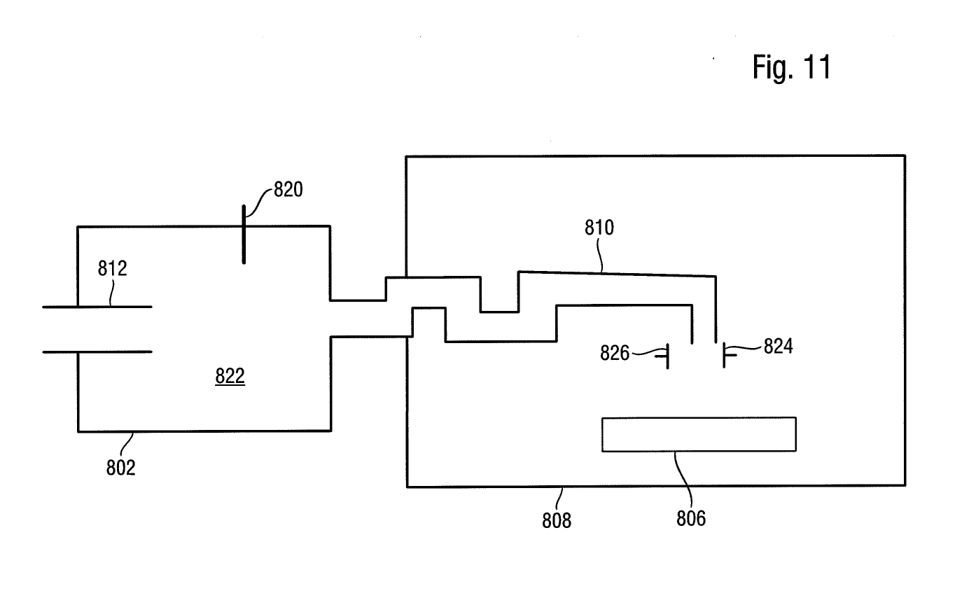

The cleaning gas is excited by a plasma in the cleaning module 802 shown in FIG. 11. For this purpose, a microwave or radio frequency is coupled into the housing 822 of the cleaning module 802 by an antenna 820, wherein the output is selected in such a manner that a plasma of the cleaning gas ignites. In the event that ions generated by the plasma excitation should penetrate into the vacuum chamber 808 through the delivery line 810, electrodes 826, 824 are provided between the delivery line 810 and the cleaning object 806 in order to filter out the ions, so that only the excited cleaning gas comes into contact with the surface to be cleaned.

The above description of the preferred embodiments has been given by way of example. From the disclosure given, those skilled in the art will not only understand the present invention and its attendant advantages, but will also find apparent various changes and modifications to the structures disclosed. The applicant seeks, therefore, to cover all such changes and modifications as fall within the spirit and scope of the invention, as defined by the appended claims, and equivalents thereof.

1. A cleaning module, comprising:
a supply for a cleaning gas, and
a device configured to excite the cleaning gas and comprising a cold cathode.

2. The cleaning module according to claim 1, wherein the cold cathode comprises a pair of electrodes, wherein one of the electrodes has at least one opening through which electrons emitted from the other electrode come into contact with the cleaning gas.

3. The cleaning module according to claim 2, wherein the cold cathode further comprises a dielectric or ferroelectric layer arranged between the electrodes.

4. A cleaning module, comprising:
a supply for a cleaning gas, and
a device configured to excite the cleaning gas and comprising a plasma generator.

5. The cleaning module according to claim 4, wherein the plasma generator comprises electrodes and the cleaning gas supply is arranged such that the cleaning gas is conveyed between the electrodes.

6. The cleaning module according to claim 1, further comprising an outlet for the excited cleaning gas.

7. The cleaning module according to claim 1, further comprising a source for at least one of an electrical and a magnetic field.

8. A cleaning module, comprising:
a supply for a cleaning gas, and
a device configured to excite the cleaning gas with a hot cathode and comprising an outlet for the excited cleaning gas and a source for at least one of an electrical and a magnetic field arranged on an external side of the outlet.

9. The cleaning module according to claim 8, wherein the source applies an electrical field and comprises electrodes or grids.

10. A cleaning module according to claim 8, wherein the source applies a magnetic field and comprises magnets.

11. The cleaning module according to claim 1, further comprising an outlet for the excited cleaning gas comprising a delivery line with at least one bend having a bending angle of less than 120 degrees.

12. The cleaning module according to claim 11, wherein the delivery line has an inner surface comprising a material having a low recombination rate for the excited cleaning gas.

13. The cleaning module according to claim 1, wherein the cleaning gas comprises at least one of a nitrogen-containing gas and a hydrogen-containing gas.

14. A cleaning module, comprising
a supply for molecular hydrogen,
a device configured to generate atomic hydrogen, and
a delivery line for at least one of the atomic hydrogen and the molecular hydrogen, wherein the delivery line has at least one bend with a bending angle of less than 120 degrees, wherein the delivery line comprises an inner surface material which has a low recombination rate for atomic hydrogen, and
wherein the supply comprises an end of flared shape, which faces the generating device.

15. The cleaning module according to claim 14, wherein the material on the inner surface of the delivery line is silicon dioxide, polytetrafluoroethylene or phosphoric acid.

16. The cleaning module according to claim 14, wherein the line consists of glass or quartz.

17. The cleaning module according to claim 14, wherein the line comprises a cooling.

18. The cleaning module according to claim 14, wherein the generating device is configured as a heating filament.

19. The cleaning module according to claim 18, wherein the heating filament is arranged spread out over a surface.

20. The cleaning module according to claim 14, wherein the supply comprises an end configured as a showerhead and faces the generating device.

21. The cleaning module according to claim 14, wherein the delivery line is configured to be moveable within the module.

22. The cleaning module according to claim 14, further comprising a source for at least one of an electrical and a magnetic field.

23. An EUV lithography device with at least one cleaning module according to claim 1.

24. An EUV lithography device, comprising:
at least one vacuum chamber, and
at least one cleaning module according to claim 14, and arranged outside of the vacuum chamber such that only the delivery line projects into the vacuum chamber.

25. The EUV lithography device according to claim 24, wherein the vacuum chamber encapsulates at least one optical element and the cleaning module is arranged such that the supply and the generating device are arranged outside of the vacuum chamber and the hydrogen generated is supplied to an interior of the vacuum chamber through the delivery line.

26. An EUV lithography device, comprising:
at least one vacuum chamber, and
at least one cleaning module according to claim 8, and arranged outside of the vacuum chamber such that the cleaning module is connected to the vacuum chamber via the outlet.

27. The EUV lithography device according to claim 26, wherein the vacuum chamber encapsulates at least one optical element.

28. A projection system for an EUV lithography device comprising at least one cleaning module according to claim 1.

29. A projection system for an EUV lithography device, comprising:
at least one vacuum chamber, and
at least one cleaning module according to claim 14 and arranged outside of the vacuum chamber such that only the delivery line projects into the vacuum chamber.

30. The projection system according to claim 29, wherein the vacuum chamber encapsulates at least one optical element, and wherein the cleaning module is arranged such that the supply and the generating device are arranged outside of the vacuum chamber and the hydrogen generated is supplied to an interior of the vacuum chamber through the delivery line.

31. A projection system for an EUV lithography device, comprising
at least one vacuum chamber, and
at least one cleaning module according to claim 8 and arranged outside of the vacuum chamber such that the cleaning module is connected to the vacuum chamber via the outlet.

32. The projection system according to claim 31, wherein the vacuum chamber encapsulates at least one optical element.

33. An exposure system for an EUV lithography device comprising at least one cleaning module according to claim 1.

34. An exposure system for an EUV lithography device, comprising:
at least one vacuum chamber, and
at least one cleaning module according to claim 14 and arranged outside of the vacuum chamber such that only the delivery line projects into the vacuum chamber.

35. The exposure system according to claim 34, wherein the vacuum chamber encapsulates at least one optical element, and wherein the cleaning module is arranged such that the supply and the generating device are arranged outside of the vacuum chamber and the hydrogen generated is supplied to an interior of the vacuum chamber through the delivery line.

36. An exposure system for an EUV lithography device, comprising:
at least one vacuum chamber, and
at least one cleaning module according to claim 8 and arranged outside of the vacuum chamber such that the cleaning module is connected to the vacuum chamber via the outlet.

37. The exposure system according to claim 36, wherein the vacuum chamber encapsulates at least one optical element.
